(19) United States
(12) Patent Application Publication
(10) Pub. No.: US 2008/0223525 A1
(43) Pub. Date: Sep. 18, 2008

(54) UNIT FOR CATCHING A FLEXIBLE COVER FOR FITTING UP A CUSHIONING

(75) Inventors: Pascal Hanteville, Nancray Sur Rimarde (FR); Etienne Poulet, Saint Bresson (FR); Sebastien Desfavris, Paris (FR)

Correspondence Address: Howard IP Law Group, P.O. Box 226, Fort Washington, PA, 19034, US

(73) Assignee: FAURECIA SIEGES D'AUTOMOBILE, Nanterre (FR)

(21) Appl. No.: 12/046,261

(22) Filed: Mar. 11, 2008

(30) Foreign Application Priority Data
Mar. 12, 2007 (FR) 07/53753

(51) Int. Cl. B32B 3/06; B32B 37/12

(52) U.S. Cl. 156/433; 428/100

(57) ABSTRACT

A system for catching a flexible cover for fitting up an automobile seat intended to cover a cushioning provided with at least one unit for catching on self-adhesive elements, the filling-up cover being provided with complementary catching elements intended to catch on the self-adhesive elements of the cushioning, the catching unit being of generally cylindrical shape and supporting at its cylindrical surface the self-adhesive elements.

### FIELD OF THE INVENTION

The present invention generally relates to the catching of a flexible fitting-up cover on a seat cushioning. The present invention more specifically relates to systems of self-adhesive type, the fitting-up cover being provided with catching elements intended to catch on self-adhesive elements of a catching unit supported by the cushioning.

### DISCUSSION OF THE RELATED ART

French patent application number 2857307 describes a fitting-up cover of the type to which the present invention applies as an example. This cover comprises a catching strip sewn to a seam allowance connecting adjacent portions of the cover. On the support side (seat cushioning), self-adhesive elements supported by another strip are directed to be able to cooperate with the cover catching strip. Generally, the strip of self-adhesive elements is placed in the mould for forming the cushioning, more specifically in grooves formed in the internal mould surface, with the self-adhesive elements directed towards the mould wall, so that the strip is caught by its rear surface in the cushioning.

The cover catching strip may also completely cover the seam allowance as well as the end edge of the seam allowance formed by the free ends of the cover borders.

A problem which is posed with the use of such catching systems is that it is difficult to have the self-adhesive strips follow non-rectilinear paths. If, on the cover side, following a curved pattern is not a problem due to the flexible character of the different components, this is not true on the cushioning side. Indeed, the strips must be properly flattened in the grooves provided in the mould so that their self-adhesive elements are directed towards the outside of the cushioning.

A cutting of the strip in short sections to approximately follow the curved path would not solve the problem, unless grooves in rectilinear sections following a curved pattern are also provided in the mould. Such a solution would however be inconvenient to implement. In particular, this would considerably increase the handling operations on positioning of the catching elements in the mould. Now, such an operation must be performed for each seat moulding.

Strips of rectilinear sections supporting self-adhesive elements and interconnected by sections of smaller width to give the strip a possibility of curvature by folding of these narrow sections are also known. Besides the risk of seeing foam be injected under the sections, the positioning of such a strip is inconvenient and requires for the operator to be careful with the positioning direction.

The positioning direction problem can be encountered in all current self-adhesive elements strips. The operator must ascertain that the strip is correctly flattened against the bottom of the mould groove, short of which the introduction of foam risks adversely affecting the subsequent catching of the cover.

### SUMMARY OF THE INVENTION

The present invention aims at overcoming all or part of the disadvantages of known systems for catching a seat cover on a cushioning by means of catching elements supported by the cover and cooperating with self-adhesive elements on the cushioning side.

An object is a solution enabling following curved patterns of the cushioning.

Another object is a solution which requires modifying neither the cover, nor the catching elements on the cover side.

Another object is to ease the positioning in a mould for forming a seat cushioning.

To achieve all or part of these objects as well as others, the present invention provides a system for catching a flexible cover for fitting up an automobile seat intended to cover a cushioning provided with at least one unit for catching on self-adhesive elements, the fitting-up cover being provided with complementary catching elements intended to catch on the self-adhesive elements of the cushioning, said catching unit being of generally cylindrical shape and supporting at its cylindrical surface said self-adhesive elements.

According to an embodiment, the cylindrical catching unit is partially integrated in a foam forming the cushioning.

The present invention also provides a catching unit intended for an automobile seat cushioning provided with self-adhesive elements, said unit having a generally cylindrical shape and comprising at its cylindrical surface said self-adhesive elements.

According to an embodiment, the cross-section of the catching unit is circular.

According to an embodiment, the catching unit has a sufficient flexibility to stand a manually-imposed curvature.

According to an embodiment, a cylindrical-shaped wrapped strip supports, on an external surface, the self-adhesive elements.

According to an embodiment, the strip is supported by a flexible core.

According to an embodiment, the self-adhesive elements are coated with polyurethane.

According to an embodiment, the catching unit includes ferrite.

According to an embodiment, the catching unit further comprises at least two rectilinear protruding fins parallel to the cylinder axis.

The present invention also provides a cushioning for an automobile seat including at least one catching unit.

The present invention also provides a seat for an automobile vehicle comprising a cushioning.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1 is a simplified lateral view of a vehicle seat of the type to which the present invention applies as an example;

FIG. 2 is a simplified representation of a vehicle seat cushioning;

FIG. 3 is a partial perspective view of an embodiment of a catching unit provided with self-adhesive elements;

FIG. 4 is a partial cross-section view of a detail of the cushioning of FIG. 2 equipped with a catching unit with self-adhesive elements;

FIG. 5 is a partial cross-section view of an example of the positioning of a catching unit in a mould for forming a seat cushioning;

FIG. 6 is a partial cross-section view of another example of the positioning of a catching unit in a mould for forming a seat cushioning;

FIGS. 7A, 7B, and 7C are cross-section views illustrating different examples of foam-tight means, associated with a catching unit with self-adhesive elements;

FIG. 8 is a cross-section view of a variation of a catching unit with self-adhesive elements; and

FIG. 9 is a partial perspective view of another embodiment of a catching unit with self-adhesive elements.

### DETAILED DESCRIPTION

The same elements have been designated with the same reference numerals in the different drawings.

The present invention will be described hereafter in relation with an example of application to automobile vehicle seats. Further, only those steps and elements which are useful to the understanding of the present invention have been shown and will be described. In particular, the cover forming and the attachment of the possible catching strips intended to cooperate with catching units on the cushioning side have not been detailed, the present invention being compatible with any usual manufacturing of such covers. Similarly, the manufacturing of the catching and self-adhesive elements has not been detailed, the present invention being here again compatible with any usual manufacturing of mutual-cooperation catching and self-adhesive elements.

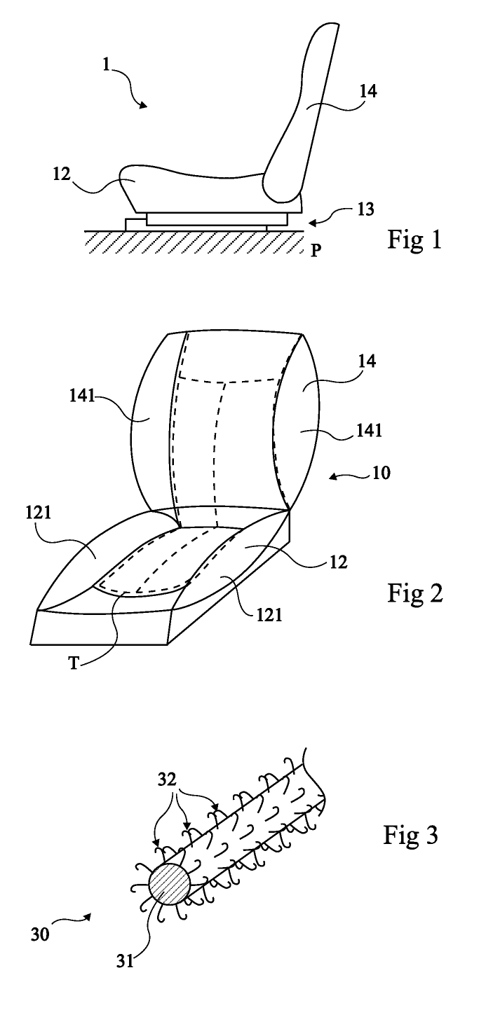

FIG. 1 is a simplified lateral view of an automobile vehicle seat 1 of the type to which the present invention applies as an example. Such a seat 1 comprises a seat bottom 12 resting, for example, via a slider mechanism 13, on floor P of the vehicle and a seat back 14, assembled on the seat bottom and generally jointed thereto.

FIG. 2 is a simplified perspective view of a cushioning 10 of a seat of the type shown in FIG. 1. Such a cushioning is intended to be covered with a seat-finishing cover (for example, textile or leather). Cushioning 10 defines seat bottom 12 and seat back 14 in foam according to shapes imposed by a foaming mould. The seats have more and more complex shapes, for example comprising lateral passenger-holding protrusions 121 and 141. The presence of such protrusions or of any other non-planar seat shape requires a cover of specific shape having portions more and more often joined by sewing. This further imposes non-rectilinear paths for catching systems. In FIG. 2, the path followed by the catching units on the cushioning has been illustrated by a dotted line T.

FIG. 3 is a partial perspective view of an embodiment of a catching unit 30 intended to cooperate with a cover catching strip. Catching unit 30 has a circular cross-section and supports self-adhesive elements 32 (for example, hooks or picots) distributed over its entire periphery. Self-adhesive elements 32 are thus distributed over the surface of a cylindrical shape. Catching unit 30 is flexible to be able to adapt to the curvatures to be followed in the mould for forming the cushioning. Its flexibility is sufficient to be manually curved. According to the embodiments which will be subsequently discussed, the cylindrical shape is directly defined by a surface supporting the self-adhesive elements or by a flexible cord 31 forming a solid or hollow core of the cylindrical unit.

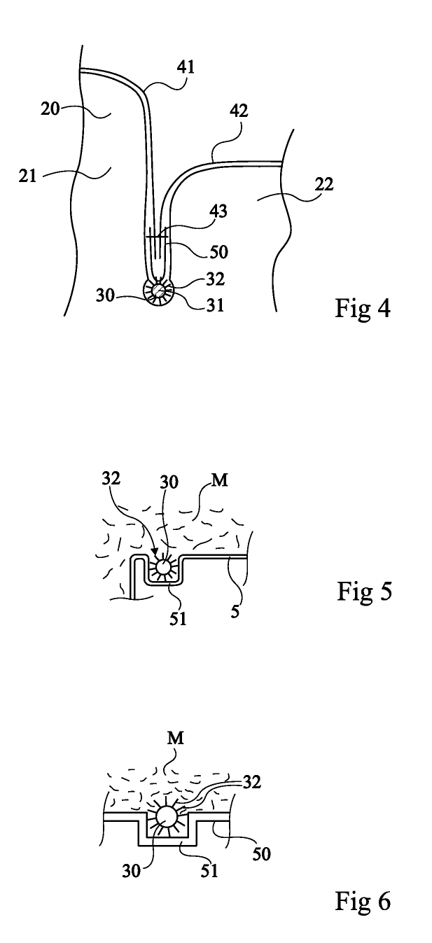

FIG. 4 is a simplified cross-section view of an embodiment of a cushioning 20 equipped with a catching unit 30 according to an embodiment. This view illustrates the case of a unit positioned at the interface between two cushioning portions 21 and 22 of different heights (for example, at the level of a protrusion 121 or 141 forming a lateral support). Catching unit 30 is positioned at the bottom of a groove joining the two cushioning portions. Cover 40 is formed in two parts 41 and 42 having their respective ends, for example, sewn together (one line 43) at the same time as to a catching strip 50 comprising catching elements (not visible in FIG. 4). In the shown example, catching strip 50 surrounds (with a U-shaped cross-section) the edges of portions 41 and 42. As a variation, the catching strip is only placed on one side of stitching 43 in portions 41 and 42 (as for example in previously-mentioned patent application 2857307). According to another variation, the stitching directly defines the catching elements.

FIG. 5 is a partial simplified view of a mould 5 for forming the cushioning. An embodiment of the type illustrated in FIG. 4 according to which catching unit 30 must be placed at the interface between two areas of different height is assumed.

A groove 51, at the corner of mould 5 defining the height change, is provided in the mould portion according to the path to be followed by catching unit 30.

FIG. 6 is a partial cross-section view of a mould 50 illustrating another example of groove 51 for receiving catching unit 30. Groove 51 is here defined in a planar surface of mould 50 or at least with no abrupt section change.

The cross-section of grooves 51 is adapted to the cross-section of catching units 30 to be housed therein so that a portion of the cross-section of catching unit 30 and above all of its self-adhesive elements is protected from foam M injected into the mould.

The pattern of grooves 51 follows that (for example, pattern T, FIG. 2) provided for the cover catching strips, including the curves.

According to a specific example, the grooves are defined in metal bars placed on or in the walls of a mould.

The use of a cylindrical catching unit at the periphery of which are distributed self-adhesive elements has many advantages.

The arranging of the element in the mould is eased since the operator needs not worry about the positioning direction of catching unit 30 in the grooves of the mould or of the bars.

Catching unit 30 may undergo a torsion enabling it to follow a curved pattern defined by the reception grooves.

The presence of self-adhesive elements over the entire periphery of catching unit 30 takes part in the attachment of this unit to the cushioning. Indeed, on injection of the foam into the mould, said foam “catches” with the accessible self-adhesive elements 32. If self-adhesive elements 32 are coated with polyurethane, this attachment is further improved (the foam forming the cushioning being itself generally made of polyurethane).

According to a variation, catching unit 30 is associated with a magnetic function. For example, its core 31 is made in the form of a resin loaded with ferrite, or a peripheral strip supporting self-adhesive elements 32 comprises ferrite particles, for example, on its internal surface.

An advantage of such a variation is that it further eases the laying of the unit in the mould, the operator using the magnetization function obtained by cooperation of the ferrite with a local magnetized area at the bottom of groove 51.

It will be ascertained to respect a tightness between catching unit 30 and the lateral groove walls to avoid, during the foam injection, for said foam to pass under catching unit 30, which would adversely affect the subsequent cover assembly function.

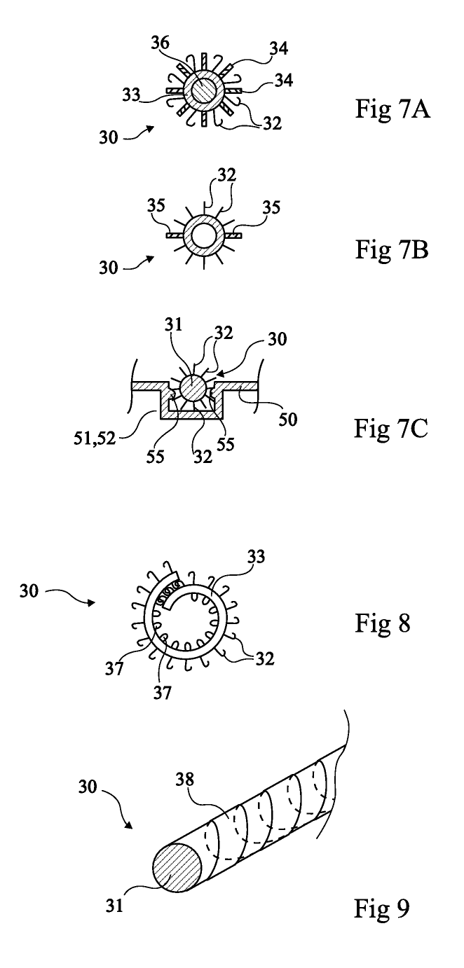

FIGS. 7A, 7B, and 7C illustrate, in cross-section views, three embodiments of foam-tightness means when catching unit 30 is placed in the mould groove.

FIG. 7A shows a first example according to which rectilinear fins 34 are distributed at the periphery of cylindrical unit 30, parallel to its axis. Fins 34 have a stiffness greater than that of self-adhesive elements 32 and cooperate with the mould groove walls (not shown) to prevent the foam from penetrating into it. Fins 34 have a height approximately equal to that of self-adhesive elements 32 to avoid hindering the subsequent catching on the catching elements of the cover. In the example of FIG. 7A, catching unit 30 is shown as a solid cord 36 (for example, made of foam) defining the cylindrical shape around which a strip 33 supporting self-adhesive elements 32 is wrapped. Strip 33 is for example glued or welded (heat or cold welding) on cord 36. It may also be sewn thereto.

FIG. 7B shows another example in which two rectilinear flexible fins 35 having a height greater than that of self-adhesive elements 32 are protruding from the surface of catching unit 30 while being parallel to its axis and at diametrically opposite positions. Fins 35 are intended to cooperate with the mould walls to ensure the tightness to foam. Such an embodiment however requires for the operator to ascertain that the fins are properly placed in the mould grooves. In the example of FIG. 7B, the core of catching unit 30 is shown as being hollow.

FIG. 7C illustrates another example in which the tightness is ensured by oval-shaped protrusions 55 protruding from the lateral walls of groove 51 of mould 50. Catching unit 30 and/or self-adhesive elements 32 are crushed against the oval-shaped protrusions to ensure the tightness. In the example of FIG. 7C, catching unit 30 is shown to be formed of one piece, for example, by direct extrusion of a cylindrical cord with a die head capable of forming self-adhesive elements 32 in its peripheral surface.

Other tightness means may be envisaged according to the respective natures of the mould and of catching units 30. For example, flexible fins for partially closing the groove may be provided on the mould side. According to another example, if the nature of self-adhesive elements 32 and of the foam allows it, the tightness may be directly ensured by the crushing of elements 32 against the lateral walls of groove 51 of the mould.

Preferably, catching organ 30 is formed to have the smallest possible cross-section (for example, a diameter ranging between 0.5 and 3 cm) to decrease foam-tightness problems, while remaining manipulable by an operator.

FIG. 8 shows a cross-section view of a variation of a catching unit 30 according to which self-adhesive elements 32 are supported by a strip 33 curved on itself and having catching elements 37 on its internal surface. Catching elements 37 for example are of the type of those present on the cover catching strips. In the shown example, elements 37 form loops catching on hooks forming self-adhesive elements 32. Such an embodiment avoids the use of a gluing or of a welding to form catching unit 30.

FIG. 9 shows another embodiment of a catching unit 30 formed of a foam core 31 around which is wrapped a band-shaped strip 38 provided with self-adhesive elements (not shown) on its external surface. Such a wrapping has the advantage of making the following of curves in the mould grooves easier. The width of the band (for example between 1 and 5 cm) is selected to ease the curvature of the catching unit.

Preferably, catching unit 30 appears as a coil of great length cuttable on request by the operator or as pre-cut sections according to the positioning locations in the mould.

Specific embodiments of the present invention have been described. Various alterations, modifications, and improvements will occur to those skilled in the art. In particular, the different alternative embodiments of catching unit 30 may be combined with various variations of tightness means with the grooves and/or with the inclusion of ferrite elements for a magnetization function on arrangement of the units in the mould. Further, the practical implementation of the present invention and of its various variations is within the abilities of those skilled in the art based on the functional description provided hereabove, especially as concerns the selection of the materials and of the dimensions of catching unit 30, of the self-adhesive elements, and of the complementary catching elements.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A system for catching a flexible cover for fitting up an automobile seat intended to cover a cushioning provided with at least one unit for catching on self-adhesive elements, the fitting-up cover being provided with complementary catching elements intended to catch on the self-adhesive elements of the cushioning, wherein said catching unit is of generally cylindrical shape and supports at its cylindrical surface said self-adhesive elements.

2. The system of claim 1, wherein the cylindrical catching unit is partially integrated in a foam forming the cushioning.

3. A catching unit intended for an automobile seat cushioning provided with self-adhesive elements, wherein said unit has a generally cylindrical shape and comprises at its cylindrical surface said self-adhesive elements.

4. The catching unit of claim 3, wherein said catching unit has a circular cross-section.

5. The catching unit of claim 3, wherein said catching unit has sufficient flexibility to stand a manually-imposed curvature.

6. The catching unit of claim 3, wherein a cylindrical-shaped wrapped strip supports, on an external surface, the self-adhesive elements.

7. The catching unit of claim 6, wherein the strip is supported by a flexible core.

8. The catching unit of claim 6, wherein the self-adhesive elements are coated with polyurethane.

9. The catching unit of claim 3, said catching unit including ferrite.

10. The catching unit of claim 3, further comprising at least two rectilinear protruding fins parallel to the cylinder axis.

11. A cushioning for an automobile seat comprising at least one catching unit provided with self-adhesive elements, wherein said unit has a generally cylindrical shape and comprises at its cylindrical surface said self-adhesive elements.

12. A seat for an automobile vehicle comprising the cushioning of claim 12.
